(19) United States
(12) Patent Application Publication
(10) Pub. No.: US 2001/0051849 A1
(43) Pub. Date: Dec. 13, 2001

(54) Emergency response information system

(76) Inventor: James W. Boone, Fulton, MD (US)

Correspondence Address: Charles W. Fallow, Shoemaker and Mattare, Suite 1203, 2001 Jefferson Davis Highway, Arlington, VA, 22202, US

(21) Appl. No.: 09/794,628

(22) Filed: Feb. 28, 2001

Related U.S. Application Data
(60) Provisional application No. 60/185,657, filed on Feb. 29, 2000.

(51) Int. Cl. G01C 21/34

(52) U.S. Cl. 701/201; 701/208; 340/902

(57) ABSTRACT

Qualified emergency personnel responding to a train accident or warehouse fire are granted directed access to the lading records of participating carriers and warehouses so that the personnel can determine which hazardous materials, if any, may be involved in the incident. The system also provides access to databases of dangerous materials so that the responders can take appropriate precautions upon arriving on the scene.

This application claims priority from provisional patent application 60/185657, filed Feb. 29, 2000.

### BACKGROUND OF THE INVENTION

This invention relates to an emergency response information system for providing emergency personnel with detailed information on the location of an emergency and the identification of hazardous materials at that location.

A problem with transportation accidents, particularly those which occur in rural or remote areas, is that emergency response personnel often have difficulty locating the accident and finding the best route to it. For example, railroad tracks often pass through rugged terrain where they are difficult to access from highways. The tracks may run along one side of a river, and the nearest access from the other side of the river may be several miles from possible accident sites. Accordingly, it would be beneficial to assist emergency response teams in locating railroad accidents, and in finding the best routes to those accidents.

Another problem with transportation accidents, whether in remote areas, or within cities, is that the vehicle(s) involved may have been carrying poisons, noxious gases, flammable liquids, explosives, or other hazardous materials. Such items are usually carried in closed vehicles whose contents may or may not be conspicuously marked on the outside of the vehicle. Emergency response teams must be able to identify such materials promptly, so that they do not aggravate the situation, and are not themselves injured, while dealing with the emergency. For example, spraying water on water-reactive chemicals can create fires or dangerous vapors. And evacuating people from the area may be more important than extinguishing a fire where certain other types of materials are involved.

Warehouse fires provide problems similar to vehicular accidents. For firefighters, arriving at a burning warehouse can be terrifying, particularly if the contents of the warehouse are unknown, because of some fatal incidents in the recent past.

### SUMMARY OF THE INVENTION

An object of the invention is to assist emergency response organizations in locating railroad accidents, and in facilitation the preplanning and identification of the best routes to those accidents.

Another object is to provide emergency responders with instant access to the most current data on the contents of vehicles and warehouses in the event of an accident, fire or other emergency.

These and other objects are attained by an emergency response information system as described below.

Carriers (e.g., railroads, motor carriers) routinely generate information files on the contents of each of their freight cars, containers and trailers. This information is used to produce bills of lading and freight bills, and in the case of hazardous materials, shipping papers required by regulatory authorities. The most accurate information is found in the carriers' lading (operating support system) records. Additionally, each rail car is identified by a unique alphanumeric serial number marked on each side of each car. Containers and trailers also generally have serial numbers.

There are classifications of all known hazardous materials, and readily available databases containing detailed information on these materials. This invention provides emergency access to, and combines information from, these three sources, and makes it available directly to emergency responders, so that they can, within minutes of arriving on the scene of an accident, determine their best cause of action to avoid injury to bystanders, neighbors and themselves, while minimizing further property loss and otherwise discharging their duties.

This system depends on providing immediate access to bill of lading or inventory records. A potential problem in implementing the system lies in the reluctance of carriers or warehousemen to permit outsiders to access to their bill of lading or inventory records, which are their most sensitive business information. They may initially have understandable concerns about permitting outside access because of possible intelligence gathering efforts by competitors, or alteration or destruction of their records by hackers. Fortunately, these concerns can be and have been overcome by providing an understanding of the potential benefits of the system, coupled with the safety of modern computer security measures, properly implemented. In fact, all major North American railroads are now participating in the system, together with several interstate motor carriers.

While the primary focus of this description is on railroad accidents, it should be understood that the principles of the invention are applicable as well to highway accidents, airplane accidents, warehouse fires, and other disasters (collectively, “incidents”): wherever the location of the incident and/or the nature of materials at the incident is unknown or in doubt.

Information from other databases is preferably integrated into or available through the system. For example, the floor plans of locomotives and passenger cars involved in an accident may be accessed so that emergency teams can find the best way into a wrecked car, avoiding internal power lines and the like. Also, a database displaying standard hazard placards and their corresponding meanings may be made available, optionally with links to the hazardous materials database.

The term “database” as used herein is not restricted to collections of data in the form of fields and records, but is used in a more general sense to include any collection of data organized in a meaningful way and accessible by a computer or communications system.

This invention is distinguished from other systems in that it does not constantly monitor the location and contents of vehicles. It is active only in emergencies, and thus avoids unnecessary overhead and the generation of unneeded information.

### BRIEF DESCRIPTION OF THE DRAWING

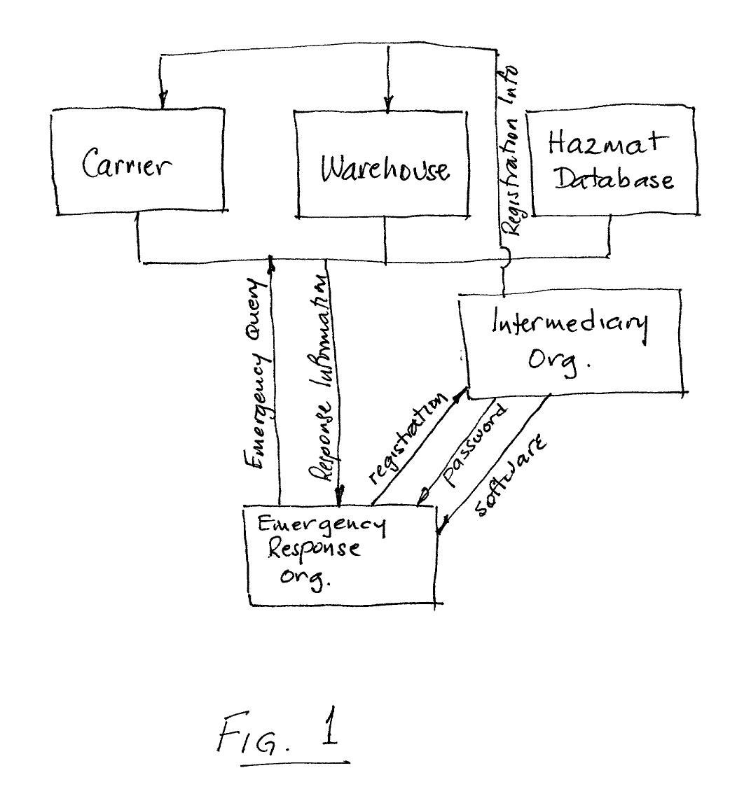

In the accompanying drawing, FIG. 1 is a diagram of an emergency response information system embodying the invention.

### DESCRIPTION OF THE PREFERRED EMBODIMENT

An emergency response information system embodying the invention includes a set of chemical containers (e.g., freight train, motor carrier or warehouse), a database identifying each such container, a database containing current information on the contents of each container, a database containing information on hazardous materials, and means for providing immediate access to each of said databases to an authorized emergency responder.

Each motor carrier or railroad (“carrier”) already maintains detailed databases containing information on the status and location of each of their vehicles, and the contents of each of their cars.

Suitable hazardous material databases also already exist. For example, the Standard Transportation Commodity Codes (STCC) assigned by the Association of American Railroads categorizes thousands of chemicals, each having a unique 7-digit code.

The United Nations has developed a similar database of dangerous goods, each identified with a four-digit code. There are set of international warning placards, each corresponding to one of the U.N. codes.

There are many other databases of hazardous materials or material safety data sheets (MSDS) which may be useful as well in practicing this invention.

The invention involves a step of securing access to the carriers' lading databases. This step is performed by a trusted intermediary organization, whose function is to ensure that the access rights will not be abused, and that the databases accessed will not be altered, corrupted or destroyed. The intermediary organization also ensures emergency responders that the required information will be available promptly, any day, and any time of day. For these services, the intermediary organization may be compensated by the participating carriers, or other sources.

The intermediary organization initially contacts, or is contacted by, an emergency response organization such as a county fire department. The response organization is requested to fill out a registration form, which is filed (preferably electronically) with the intermediary organization. After carefully scrutinizing the application and satisfying itself that the organization is authentic, the intermediary assigns a password to the response organization and provides software to the response organization which it can install and use to access carrier's lading databases, hazardous materials databases, and others. The software can be provided in CD-ROM form, or downloaded over the internet, and may or may not include static databases of useful information, such as the U.N. placard system. Active links to databases available on the wide area network (e.g., Internet) used by the system may also be provided. At this point the response organization is considered “qualified” to use the system.

After qualifying a response organization, the intermediary forwards registration information on that organization, including the password(s) assigned, to its qualified carriers and warehouses.

The participating carriers manage their own information, permitting access to inquiring qualified emergency responders only when they are satisfied requests are authentic. It is recommended that bills of lading information be copied or mirrored to a separate file which can be accessed through a firewall. Having a dedicated file thus available makes emergency response quicker, because there are no competing routine accesses being made from within the company, and firewalls protect the company's primary information sources.

The carrier is given the ability to monitor inquiries which have been made of its databases through the system. For example, selected pagers may be activated whenever an emergency access is made. The monitoring scheme may be designed by the carrier's own information manager, or by by the intermediary organization or a third party. The carriers may sit on a steering committee at the intermediary organization, and thus provide important feedback on security measures and the like.

The databases are accessed over an wide area network such as the Internet by means of a personal computer or the like running a program or application, provided by the intermediary organization, which provides secure access to the databases, and displays information retrieved from them. The details of the software are not important to an understanding of this invention; however, a reproduction of the operation manual for the software is appended to this description.

The software is preferably written to display messages and accept commands in more than one language, for example English, French and Spanish. Such translation is a matter of ordinary programming skill.

Operation of the invention is described in the following hypothetical example.

### Example I

On a snowy Tuesday morning in February, Amtrak train #5, the California Zephyr, carrying 433 passengers from Chicago to San Francisco, leaves Hastings, Nebr., a few minutes later than its scheduled departure time of 3:18am. Quickly accelerating to the authorized track speed of 79 mph, the train prepares to cross a farm grade crossing a few miles from the station. A farm truck slowly creeps out onto the crossing, and before the engineer can even fully apply the emergency brakes, the truck is struck full force by the train. The train strews the remains of the truck for almost a mile before it finally comes to rest on a culvert over a small stream. While the engine and passenger cars remain upright, the engineer and assistant engineer are severely injured and the truck driver is instantly killed in the collision. Radio contact from the locomotive is lost from damage. Fuel from the truck, and its cargo of farm chemicals in drums and packages are strewn all along the railroad, and several small fires are started.

The conductor of the train calls 911 on his cell phone to alert local authorities of the accident. The conductor knows only which train he is on, that there is a railroad signal (Signal 254 West) near his car, and that something at the front of the train is burning, producing a smell he cannot readily identify.

The 911 emergency dispatcher who receives the call redirects the matter to the local volunteer fire department, whose personnel have received initial hazardous materials training and awareness, but have never responded to this type of grade crossing accident. Initially, the firemen have no specific information as to the exact whereabouts of the train. Fortunately, however, they have access to an emergency response system as described above.

Using the mapping feature of the invention, they are able quickly to learn, from the caller's signal location information, that the head of the train is about half a mile short of a grade crossing on County Road 3152, to which they proceed. One of the firemen races to that location in a pickup truck arriving three minutes before the rest of the fire equipment. He sprints down the track toward the train, and upon drawing close, sees the lead engine, with a small fire burning alongside. Immediately radioing for a pumper to extinguish the fire, he continues on toward the train. The pumper navigator, using a laptop equipped with the invention, notes a clearing in the farm field near the location that is solid enough to cross with the apparatus, and quickly proceeds to the location.

Using his radio, the fireman summons other equipment and ambulances to rescue the engine crew, and other arriving fire and police personnel begin the triage of passengers, who fortunately suffer only minor injuries. Noting the chemicals on the train, and the placards on the drums and packages, the incident commander looks up its dangers on his laptop, and warns personnel to not step in any of it, summoning a hazardous materials team from the county. Railroad personnel and police establish a cleanup zone, and learn from the chemical database that the chemicals and fuel may present a problem at the small stream. Accordingly, after initial fire suppression activities conclude, diking and preventive materials are laid out and deployed and the release is mitigated. Approximately ten hours later, the incident command is terminated, all equipment removed from the scene, and the railroad is restored to service.

The above example shows how the multifaceted capabilities of the invention come into play in an intermodal (e.g. railroad and highway) incident.

The user's manual for the presently preferred software supplied by the intermediary to emergency responders is reproduced in the appendix that follows.

I claim:

1. An emergency response information system comprising
a database containing confidential carrier information on current contents of a container,
a database containing information on various hazardous materials, and
means for providing a qualified emergency response organization with direct access to both said contents database and said hazardous materials database.

2. The invention of claim 1, wherein the container is a warehouse, and the contents database includes information on all hazardous materials within the warehouse.

3. The invention of claim 1, wherein the container is a warehouse, and the contents database includes information on substantially all items within the warehouse.

4. The invention of claim 1, wherein the container is a freight car and the contents database includes information on the contents of the car.

5. The invention of claim 4, wherein the contents database identifies any hazardous material in the car.

6. An emergency response information system for a rail carrier, said system comprising
a database containing confidential carrier information on current contents of each of said freight cars,
a database containing information on various hazardous materials,
means for providing a qualified emergency response organization with direct access to said car location database, said contents database and said hazardous materials database.

7. A method of enabling emergency responders to identify any hazardous materials at an incident site, said method comprising steps of
qualifying emergency responders to access lading records of a carrier,
receiving an inquiry from an emergency responder,
verifying that said responder is qualified,
providing said qualified emergency responder direct monitored access to said lading records, and
providing said qualified emergency responder access to a database of hazardous materials,
whereby said responder can identify sources of hazardous materials at said site, and learn how best to handle said hazardous materials.

8. A method as recited in claim 7, further comprising a step of providing access to a car configuration database whereby said responder can determine how best to enter the car and what areas to avoid when cutting into the car.

9. A method of enabling emergency responders to locate a train accident based on railroad landmarks, said method comprising steps of
providing a graphic display of a railroad map having local railroad landmarks thereon, and
overlaying said railroad map on a graphic display of a highway map whereby one viewing said displays can determine the location of, and best highway routes to, said train accident.
